(19) United States
(12) Patent Application Publication
(10) Pub. No.: US 2007/0205904 A1
(43) Pub. Date: Sep. 6, 2007

(54) Solar Powered Goose Repellant Automated Laser System- (GRS UNIT)

(75) Inventor: Jeremy Craig Froehner, Jersey City, NJ (US)

Correspondence Address: JEREMY C. FROEHNER, 43 COLLEGE DRIVE, APT. 4-E, JERSEY CITY, NJ, 07305-1030, US

(73) Assignee: Jeremy Craig Froehner, Jersey City, NJ (US)

(21) Appl. No.: 11/308,092

(22) Filed: Mar. 6, 2006

(51) Int. Cl. G08B 23/00

(52) U.S. Cl. 340/573.2

(57) ABSTRACT

This solar powered goose repellant (GRS) Unit will harmlessly keep away Canada geese, ducks, crows, gulls, vultures, cormorants, egrets, and herons. It will do this by sensing the animals via PIR sensor, recharging via solar cells and scare the geese away via 532 nm DPSS Green Laser that will disperse and pivot side to side throw its holographic diffraction grating lens.

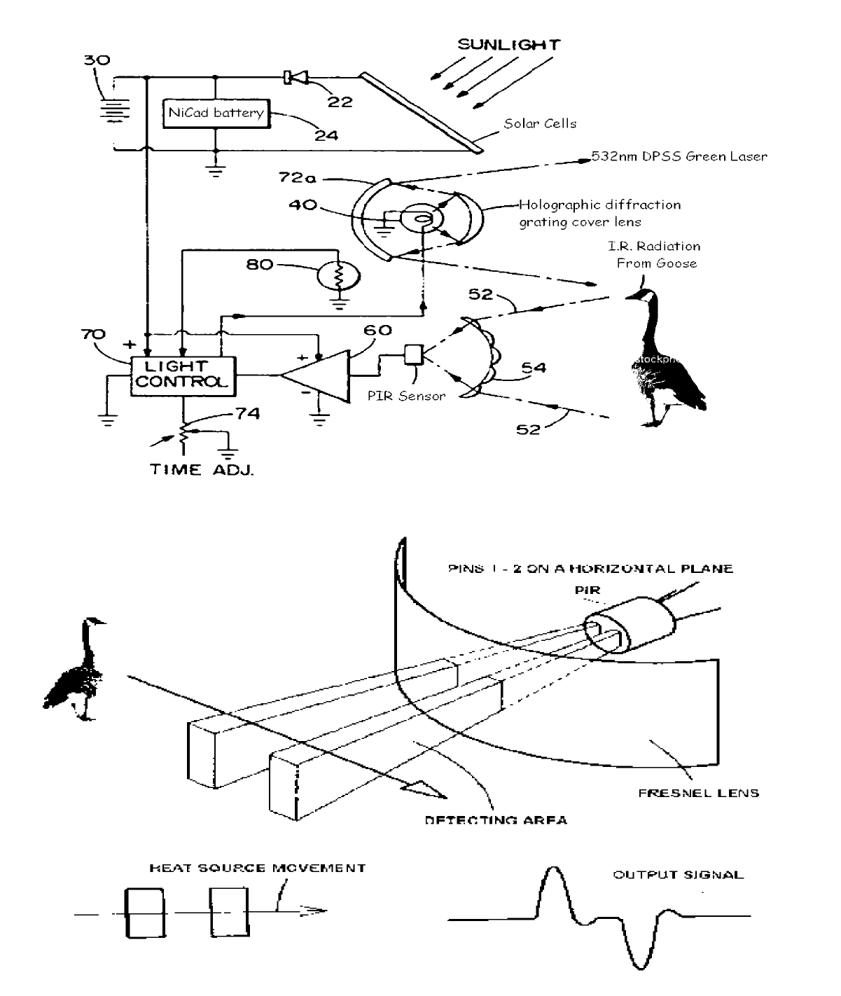

The Solar powered Goose Repellant System uses specialized automated lasers, and include a goose sensing mechanism and or timer. The goose sensing mechanism is a pyroelectric passive infrared (PIR) sensor that detects infrared radiation of objects including geese and other animals. This is in conjunction with a battery recharged via solar cells, and a control circuit coupled to the PIR sensor. The solar cells are wired directly to the battery through a diode. The unit uses 2 rechargeable NiCad battery's which produce about 9.2 volts each and can store a maximum of approximately 2500 milliamp-hours. The control circuit guarantees that the 532 nm DPSS Green Laser Light is turned on by the battery only when the sensor senses the presence of a moving target or by timer. The systems may include a light detector which is utilized to prevent the system from activating in daylight.

The powerful green laser, unlike red lasers, emits a visible green ray of light that disperses throw a holographic diffraction grating cover lens. The range in the laser is up to 545,000 ft in darkness (approx) & tests have shown that repeated use will substantially reduce or eliminate geese, requiring only occasional follow-up. This unit will harmlessly keep away Canada geese, ducks, crows, gulls, vultures, cormorants, egrets, and herons. In case of nightly overuse, a timer is utilized to turn off the unit after a desired period of run time. This will intern limit the activity of the laser and reserve power for use throughout the night. The laser system is solar powered based unit and is in full compliance with the BRH for a class IIIB certification. This unit will be for professional bird management use only.

What is claimed is:

1. A solar powered goose repellant automated laser system, comprising: (a) a solar cell for receiving sunlight and for generating charging current therefrom; (b) a rechargeable power source coupled to said solar cell for receiving said current and charging as a result thereof; (c) a contactless goose sensing mechanism means for monitoring, without requiring contact between said contactless pyroelectric passive infrared (PIR) sensor means and an object, in an area near said sensor means, the movement into the area of the object including geese and other animals or a source of radiation, and for providing a signal indicative thereof; (d) an amplifier coupled to said contactless sensor means and to said rechargeable power source for amplifying said signal; (e) a control circuit coupled to said amplifier, to said rechargeable power source, and to a Class-IIIb OEM, <50 mW green laser that disperses throw a holographic diffraction grating, including switching means for causing said rechargeable power source to turn on said 3M laser with a Wavelength of 532 nm source when an amplified signal is received from said amplifier, and timing means for causing said switching means to disconnect from said rechargeable power source after a desired length of time has transpired.
